(19) United States
(12) Patent Application Publication
(10) Pub. No.: US 2024/0383443 A1
(43) Pub. Date: Nov. 21, 2024

(54) WIPING DEVICE

(71) Applicant: MITSUBA Corporation, Gunma (JP)

(72) Inventor: TOSHIYUKI AMAGASA, Gunma (JP)

(73) Assignee: MITSUBA Corporation, Gunma (JP)

(21) Appl. No.: 18/416,892

(22) Filed: Jan. 19, 2024

(30) Foreign Application Priority Data
May 15, 2023 (JP) 2023-080061

(51) Int. Cl. B60S 1/08

(52) U.S. Cl. CPC B60S 1/08

(57) ABSTRACT

Provide is a wiping device that wipes off rainwater from a wiped surface by reciprocating a wiper blade by a power source. The wiping device includes a drive part that drives a power source; and an operation part that outputs an operation signal specifying a standby position of the wiper blade to the drive part.

### CROSS-REFERENCE TO RELATED APPLICATION

This application claims the priority benefits of Japanese application no. 2023-080061, filed on May 15, 2023. The entity of the above-mentioned patent application is hereby incorporated by reference herein and made a part of this specification.

### BACKGROUND

### Technical Field

The disclosure relates to a wiping device.

### Related Art

Patent Literature 1 below discloses small-sized mobility vehicles such as roofed motorcycles, tricycles, scooters, and motorcycles. These small-sized mobility vehicles are equipped with a vertically long front windshield, and are equipped with a wiping device that wipes off rainwater from a surface of the front windshield (wiped surface) with a pantograph wiper.

### CITATION LIST

### Patent Literature

[Patent Literature 1] JP2002-512919

In such a wiping device for small-sized mobility vehicles, the standby position of the wiper blade when the operation is stopped is determined in advance. That is, when the wiper blade is not in operation, its standby position is near the left end or right end of the front windshield.

However, for example, when maintaining a small-sized mobility vehicle, there are cases where the standby position of the wiper blade is desired to be changed. Conventional wiping devices cannot cope with such a requirement of changing the standby position, so there is room for improvement in usability.

The disclosure provides a wiping device in which the standby position of a wiper blade may be changed.

### SUMMARY

In the disclosure, as a first solution for the wiping device, a wiping device that wipes off rainwater from a wiped surface by reciprocating a wiper blade by a power source is provided, in which a drive part that drives the power source, and an operation part that outputs an operation signal specifying a standby position of the wiper blade to the drive part are included.

### BRIEF DESCRIPTION OF THE DRAWINGS

FIG. 1 is a block diagram showing the functional components of a wiping device A according to an embodiment of the disclosure.

FIG. 2 is a schematic diagram showing a setting switch according to an embodiment of the disclosure.

FIG. 3 is a flowchart showing the operation of the wiping device A according to an embodiment of the disclosure.

FIG. 4A and FIG. 4B are schematic diagrams showing a standby position of a wiper blade according to an embodiment of the disclosure.

### DESCRIPTION OF THE EMBODIMENTS

In the disclosure, as a first solution for the wiping device, a wiping device that wipes off rainwater from a wiped surface by reciprocating a wiper blade by a power source is provided, in which a drive part that drives the power source, and an operation part that outputs an operation signal specifying a standby position of the wiper blade to the drive part are included.

In the disclosure, as a second solution for the wiping device, in the first solution, the drive part changes the standby position of the wiper blade based on an operation time indicated by the operation signal.

In the disclosure, as a third solution related to the wiping device, in the first or second solution, the operation part is an automatic return type toggle switch.

In the disclosure, as a fourth solution related to the wiping device, in the first or second solution, the wiped surface is a surface of a front windshield in a small-sized mobility vehicle.

According to the disclosure, it is possible to provide a wiping device in which the standby position of a wiper blade may be changed.

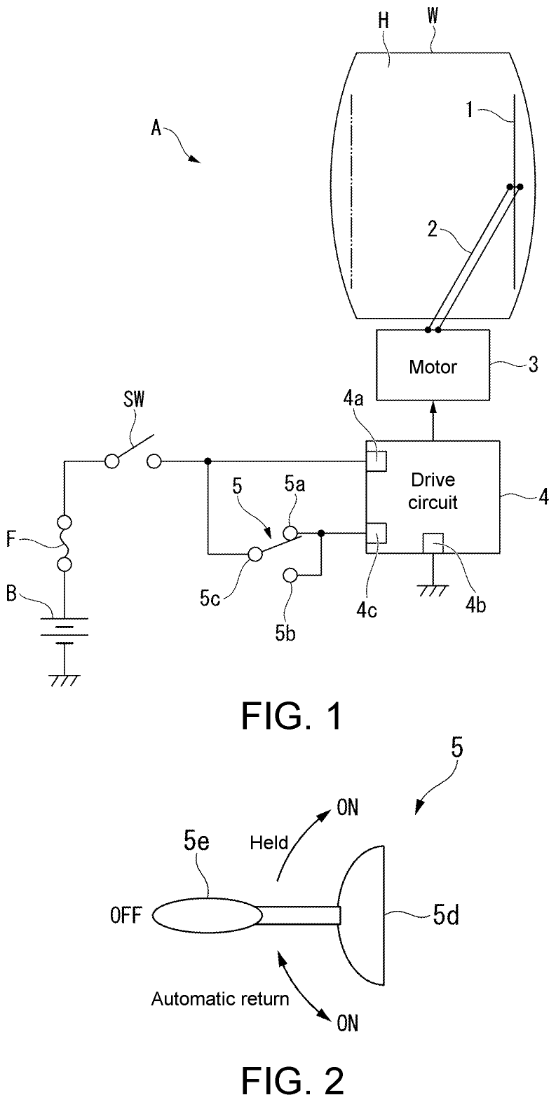

An embodiment of the disclosure will be described with reference to FIGS. 1 to 4B. A wiping device A according to this embodiment is mounted on small-sized mobility vehicles such as a roofed motorcycle, a roofed tricycle, a scooter, and a motorcycle, and is a device that wipes off rainwater adhering to the surface of a front windshield (wiped surface).

This wiping device A includes a wiper blade 1, a wiper arm 2, a motor 3, and a drive circuit 4, as shown in FIG. 1. Among these components of the wiping device A, the motor 3 corresponds to a power source of the disclosure. Further, the drive circuit 4 corresponds to a drive part of the disclosure. Further, a setting switch 5 corresponds to an operation part of the disclosure.

The wiper blade 1 is a rod-shaped member that comes into contact with a wiped surface H of a front windshield W. The wiper blade 1 is connected to an output shaft (rotating shaft) of the motor 3 via the wiper arm 2, and wipes off rainwater adhering to the wiped surface H by reciprocating (swinging) on the wiped surface H based on the rotation power of the motor 3.

The wiper blade 1 may select one of two positions as a standby position when not in operation; the details thereof will be described later. One of the two positions is a position of the wiper blade 1 shown in FIG. 1, which is a position near the right end of the wiped surface H toward the wiped surface H. Moreover, the other of the two positions is a position shown by a two-dot chain line (imaginary line) in FIG. 1, which is a position near the left end of the wiped surface H when facing the wiped surface H.

When the position near the right end of the wiped surface His set as the standby position, the wiper blade 1 reciprocates between the position near the right end and the position near the left end with the position near the right end as a base point. On the other hand, when the position near the left end of the wiped surface His set as the standby position, the wiper blade 1 reciprocates between the position near the left end and the position near the right end with the position near the left end as a base point.

The wiper arm 2 is a long member with one end connected to a middle part of the wiper blade 1 and the other end connected to the output shaft of the motor 3. The wiper arm 2 is a link mechanism that is interposed between the wiper blade 1 and the output shaft of the motor 3 so as to convert rotational motion of the output shaft of the motor 3 into reciprocating motion of the wiper blade 1. The wiper arm 2 also functions as a biasing member that presses the wiper blade 1 toward the wiped surface H.

The motor 3 is a power source for reciprocating the wiper blade 1. That is, the motor 3 is an electric motor that rotates the output shaft based on a drive signal input from the drive circuit 4. The output shaft of the motor 3 is mechanically connected to the wiper blade 1 via the wiper arm 2. Moreover, although the motor 3 and the drive circuit 4 are shown as separate functional components in FIG. 1, the motor 3 and the drive circuit 4 may be configured as a motor module that is integrated as a component.

The drive circuit 4 is an electric circuit that includes a power supply terminal 4a, a GND terminal 4b, and a control terminal 4c, and generates the drive signal based on DC power (power supply power) supplied from a battery B (power supply). The power supply terminal 4a is connected to one end of a power switch SW, the GND terminal 4b is grounded, and the control terminal 4c is connected to two selection contacts 5a and 5b of the setting switch 5.

The drive circuit 4 generates a drive signal based on the operation signal input from the setting switch 5 to the control terminal 4c in addition to the DC power supplied to the power supply terminal 4a; the details thereof will be described later. The operation signal is an electrical signal that specifies the standby position of the wiper blade 1 to either a position near the right end or a position near the left end.

That is, when the wiping device A is in operation, the drive circuit 4 drives the motor 3 such that the wiper blade 1 reciprocates between the position near the right end and the position near the left end. Further, when the wiping device A is not in operation, the drive circuit 4 drives the motor 3 such that the wiper blade 1 stops (standby) at a standby position specified by the operation signal.

The setting switch 5 is a selection switch that includes one common contact 5c in addition to the pair of selection contacts 5a and 5b. The pair of selection contacts 5a and 5b are connected to the control terminal 4c of the drive circuit 4, and the common contact 5c is connected to one end of the power switch SW and the power supply terminal 4a of the drive circuit 4. Such a setting switch 5 corresponds to the operation part of the disclosure.

To further explain the setting switch 5, the setting switch 5 is an automatic return type toggle switch as shown in FIG. 2. That is, the setting switch 5 mechanically includes a main body 5d and an operating lever 5e (movable lever). The main body 5d is a housing that accommodates the pair of selection contacts 5a, 5b and the one common contact 5c, and movably supports a tip of the operating lever 5e.

The operating lever 5e may be tilted downward or upward from a reference position as shown in FIG. 2. When the operating lever 5e is tilted downward, the common contact 5c is connected to one selection contact 5a. On the other hand, when the operating lever 5e is tilted upward, the common contact 5c is connected to the other selection contact 5b.

Further, when the operating lever 5e is tilted downward, it automatically returns to the reference position based on the automatic return function. That is, when tilted downward, the common contact 5c is automatically disconnected from the one selection contact 5a (ON state) and becomes OFF state. On the other hand, when tilted upward, the operating lever 5e is held upward without automatically returning to the reference position. That is, when tilted upward, the common contact 5c maintains the connection (ON state) with the other selection contact 5b.

Operating power is supplied to such a wiping device A from the battery B via the power switch SW. The power switch SW is an open/close switch including a pair of contacts. One contact of the power switch SW is connected to the power supply terminal 4a of the drive circuit 4 and the common contact 5c of the setting switch 5.

Further, the other contact of the power switch SW is connected to a positive electrode of the battery B via a fuse F. That is, the other contact in the power switch SW is connected to one end of the fuse F. In the battery B, the positive electrode of is connected to the other end of the fuse F, and a negative electrode is grounded. This battery B outputs DC power of a predetermined voltage (battery voltage Vb) to the wiping device A.

Moreover, the fuse F is a safety device against excessive output current (overcurrent) of the battery B. That is, the fuse F blows when a current value of the operating power supplied from the battery B to the wiping device A exceeds a predetermined value, changing the connection state of two ends to a disconnected state. By blowing, the fuse F cuts off the supply of operating power from the battery B to the wiping device A.

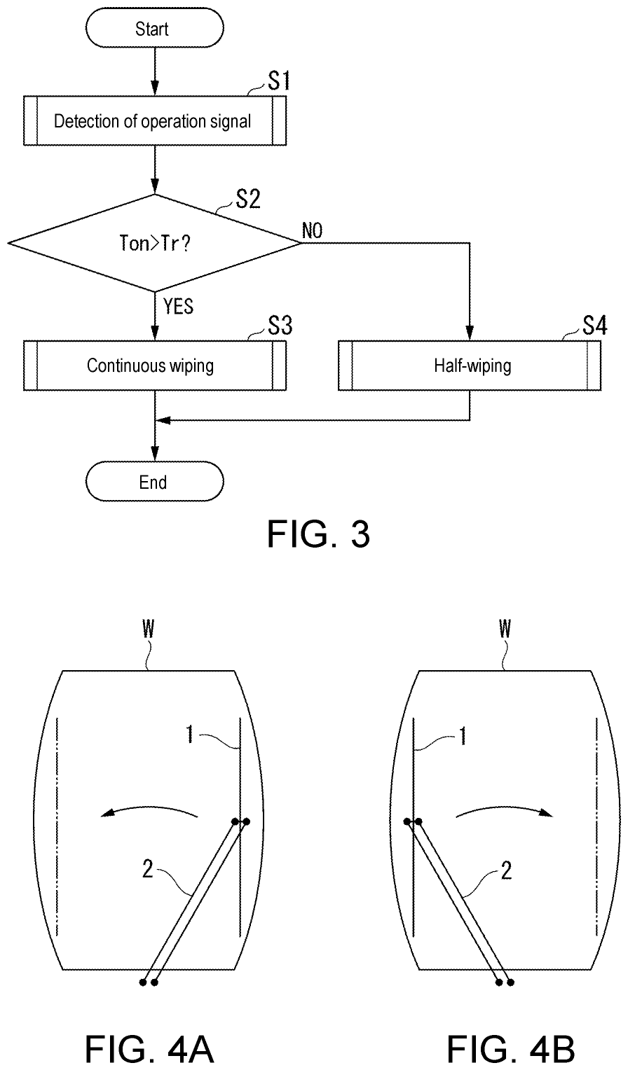

Next, characteristic operations of the wiping device A according to this embodiment will be described with reference to the flowchart shown in FIG. 3.

In use of this wiping device A, the drive circuit 4 detects an input of an operation signal from the setting switch 5 (step S1). A driver of the small-sized mobility vehicle specifies an operating mode of the wiping device A by operating the setting switch 5. For example, when operating the wiping device A in a normal mode, that is, when reciprocating the wiper blade 1 continuously, the driver tilts the operating lever 5e of the setting switch 5 upward from the reference position.

As a result, the setting switch 5 changes from the OFF state to the ON state, and the common contact 5c is connected to the other selection contact 5b. Further, when the operating lever 5e is tilted upward from the reference position, the state of the operating lever 5e is maintained, such that the connection state between the common contact 5c and the other selection contact 5b is maintained.

That is, when the operating lever 5e is tilted upward from the reference position, the battery voltage Vb is applied to the control terminal 4c of the drive circuit 4 over a long period of time. When it is determined that an application period Ton of the battery voltage Vb to the control terminal 4c exceeds a predetermined threshold value Tr (Step S2), the drive circuit 4 performs continuous wiping of the wiped surface H by continuously reciprocating the wiper blade 1 (Step S3).

On the other hand, when the wiping device A is operated in the standby position operation mode, that is, when the wiper blade 1 is moved forward only once, the driver of the small-sized mobility vehicle tilts the operating lever 5e of the setting switch 5 downward from the reference position. In this case, the automatic return function of the setting switch 5 causes the operating lever 5e to once fall downward and then quickly return to the reference position.

That is, when the operating lever 5e of the setting switch 5 is tilted downward from the reference position, the battery voltage Vb is applied to the control terminal 4c of the drive circuit 4 for a relatively short period of time. When it is determined that the application period Ton of the battery voltage Vb to the control terminal 4c is equal to or less than the threshold value Tr (Step S2), the drive circuit 4 performs half-wiping of the wiped surface H by making the wiper blade 1 move forward only once (Step S4).

For example, in a state where the wiper blade 1 is on standby (stopped) at a position near the right end of the front windshield W as shown in FIG. 4A, when the operating lever 5e of the setting switch 5 is tilted downward from the reference position, the wiper blade 1 moves forward only once, and the standby position of the wiper blade 1 is changed from the position near the right end to the position near the left end (imaginary line position).

Further, in a state where the wiper blade 1 is on standby (stopped) at a position near the left end of the front windshield W as shown in FIG. 4B, when the operating lever 5e of the setting switch 5 is tilted downward from the reference position, the wiper blade 1 moves forward only once, and the standby position of the wiper blade 1 is changed from the position near the left end to the position near the right end (imaginary line position).

Here, the application period Ton of the battery voltage Vb at the control terminal 4c corresponds to a period during which the operating lever 5e of the setting switch 5 is tilted upward or downward, that is, the operation time of the setting switch 5. That is, the drive circuit 4 (drive part) in this embodiment changes the standby position of the wiper blade 1 based on the operation signal input from the setting switch 5.

According to this embodiment, it is possible to provide a wiping device A that is capable of changing the standby position of the wiper blade 1, since the wiping device A, which wipes off rainwater from the wiped surface H by reciprocating the wiper blade 1 with the motor 3 (power source), includes the drive circuit 4 (drive part) that drives the motor 3 (power source), and the setting switch 5 (operation part) that outputs an operation signal specifying the standby position of the wiper blade 1 to the drive circuit 4 (drive part).

Further, according to this embodiment, the drive circuit 4 (drive part) changes the standby position of the wiper blade 1 based on the operation time Ton indicated by the operation signal input from the setting switch 5 (operation part). That is, the standby position of the wiper blade 1 is changed based on the relation in length between the operation time Ton and the threshold value Tr. Thus, according to this embodiment, it is possible to provide a wiping device A in which the standby position of the wiper blade 1 can be easily changed.

Further, according to this embodiment, an automatic return type toggle switch is configured as the setting switch 5 (operation part). That is, according to this embodiment, switching between the normal mode and the standby position operation mode in the operating mode is easy. According to this embodiment, it is easy to add a standby position operation mode to an existing wiping device.

Further, according to this embodiment, the wiped surface H is the surface of the front windshield W in a small-sized mobility vehicle. That is, in this embodiment, the wiping device according to the disclosure is applied to wiping the front windshield W in a small-sized mobility vehicle. According to this embodiment, it is easy to change the standby position of the wiper blade 1 in a small-sized mobility vehicle.

Moreover, the disclosure is not limited to the embodiment described above, and for example, the following modifications may be considered.
(1) In the above embodiment, the wiping device according to the disclosure is applied to wiping the front windshield W in a small-sized mobility vehicle, but the disclosure is not limited thereto. The wiping device according to the disclosure may also be applied to various vehicles other than small-sized mobility vehicles, such as general four-wheeled vehicles, cultivation vehicles such as tractors, or civil engineering construction vehicles such as bulldozers.
(2) In the above embodiment, the standby position of the wiper blade 1 is changed based on the operation time Ton indicated by the operation signal of the setting switch 5 (operation part), but the disclosure is not limited thereto. The standby position of the wiper blade 1 may be changed based on a physical quantity other than the operation time Ton indicated by the operation signal. For example, the standby position of the wiper blade 1 may be changed based on a voltage level of the operation signal. In this case, it is necessary to configure a circuit component or an input circuit other than the setting switch 5 as the operation part.
(3) In the above embodiment, the setting switch 5 is configured as the operation part, but the disclosure is not limited thereto. That is, a circuit component or an input circuit other than the setting switch 5 may be configured as the operation part. As for the operation part, it is preferable to select operability as the top priority, followed by selection from the viewpoint of suppressing increase in cost.
(4) In the above embodiment, the standby position of the wiper blade 1 is set at a position near the right end or a position near the left end of the front windshield W, but the disclosure is not limited thereto. A position other than the position near the right end or the position near the left end, such as the center position of the front windshield W, may be set as the standby position.
(5) In the above embodiment, when changing the standby position of the wiper blade 1, the wiper blade 1 is moved forward only once. That is, in the embodiment described above, the standby position of the wiper blade 1 is changed by performing half-wiping of the wiped surface H. However, the disclosure is not limited thereto. For example, the standby position of the wiper blade 1 may be changed by performing half-wiping once after a full wiping (reciprocating motion) for a predetermined number of times.

What is claimed is:

1. A wiping device that wipes off rainwater from a wiped surface by reciprocating a wiper blade by a power source, the wiping device comprising:
a drive part that drives the power source; and
an operation part that outputs an operation signal specifying a standby position of the wiper blade to the drive part.

2. The wiping device according to claim 1, wherein the drive part changes the standby position of the wiper blade based on an operation time indicated by the operation signal.

3. The wiping device according to claim 1, wherein the operation part is an automatic return type toggle switch.

4. The wiping device according to claim 2, wherein the operation part is an automatic return type toggle switch.

5. The wiping device according to claim 1, wherein the wiped surface is a surface of a front windshield in a small-sized mobility vehicle.

6. The wiping device according to claim 2, wherein the wiped surface is a surface of a front windshield in a small-sized mobility vehicle.
